(19) United States
(12) Patent Application Publication
(10) Pub. No.: US 2010/0153465 A1
(43) Pub. Date: Jun. 17, 2010

(54) SYSTEM AND METHOD FOR PROVIDING IMAGE GEO-METADATA MAPPING

(75) Inventor: Sudeep Dasgupta, Irving, TX (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES LLC, Temple Terrace, FL (US)

(21) Appl. No.: 12/336,606

(22) Filed: Dec. 17, 2008

(51) Int. Cl. G06F 17/30; G06K 9/00

(52) U.S. Cl. 707/802; 382/100; 707/E17.018

(57) ABSTRACT

Embodiments of the present disclosure are directed to a system and method including capturing one or more images at a location, wherein metadata is associated with each of the one or more images, determining location information associated with the location; and obtaining one or more addresses in a contact address book. The system and method also including analyzing the metadata associated with the one or more images, the location information, and the one or more addresses in the contact address book by correlating at least two of the metadata associated with the one or more images, the location information, and the one or more addresses in the contact address book; and displaying result of the analysis to a user.

### BACKGROUND INFORMATION

Many problems exist since the inception of wireless user devices (e.g., cellular telephone, mobile computer), for example, difficulty in inputting location information (e.g., street address, city, state, province, country, and/or zip code) into the wireless user devices. The determination of the address for an entry in a contact address book may be difficult, since the addresses may change and/or the location information may not be apparent. For example, the location information associated with an address (e.g., home address and/or work address) may change because the occupant may move to a different address. Often times, the location information associated with different addresses may not be apparent because of missing street numbers and/or signs, new neighborhood, and/or at night where the location information can not be discerned. In the event that location information associated with an address may not be available, the wireless user device may be unable to store the location information associated with the one or more addresses. In addition, current users of wireless user devices may not remember characteristics associated with the location information stored in the wireless user devices. Therefore, users of wireless user devices may not find the location stored in the wireless user devices. For example, users of wireless user devices may not be able to find a location according to the location information stored in the wireless user devices because of missing street numbers and/or signs. Therefore, the existing methods of determining and/or inputting location information associated with different addresses may be unreliable and/or unhelpful. Therefore, an improved determination and/or inputting location information associated with different addresses may be needed in order to obtain accurate location information and/or an image of the location.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 illustrates a system architecture for providing image geo-metadata mapping, in accordance with exemplary embodiments;

FIG. 2 illustrates a detailed block diagram of a mobile user agent, in accordance with exemplary embodiments; and

FIG. 3 illustrates a flowchart for providing image geo-metadata mapping, in accordance with exemplary embodiments.

These and other embodiments and advantages will become apparent from the following detailed description, taken in conjunction with the accompanying drawings, illustrating by way of example the principles of the various exemplary embodiments.

### DETAILED DESCRIPTION OF EMBODIMENTS

A system and method may include various exemplary embodiments for providing image geo-metadata mapping. The image geo-meta mapping method may include one or more images to identify a location and/or one or more physical characteristics associated with the location. The location where the one or more images are taken may be identified by location information (e.g., physical street address and/or global positioning system (GPS) coordinates). A relationship may be established between the one or more images and the location information to identify the location. Also, a relationship may be established between the one or more images, the location information, and/or one or more addresses in a contact address book. The image geo-metadata mapping system may store the one or more images, the location information and/or the one or more addresses in the contact address book. Also, the one or more images, the location information and/or the one or more addresses in the contact address book may be stored at a service provider. A user associated with the wireless user device may view and/or modify the one or more images and/or the location information associated with the one or more addresses in the contact address book.

The description below describes location modules, image modules, mobile user agents, service portals, service providers and network elements that may include one or more modules, some of which are explicitly shown, others are not. As used herein, the term “module” may be understood to refer to computing software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but is not limited to, a compact disc (CD), a digital versatile disc (DVD), a floppy disk, a hard drive, read only memory (ROM), random access memory (RAM), as well as other physical media capable of storing software, and/or combinations thereof. The functions described as being performed at various components may be performed at other components, and the various components may be combined and/or separated. Other modifications also may be made.

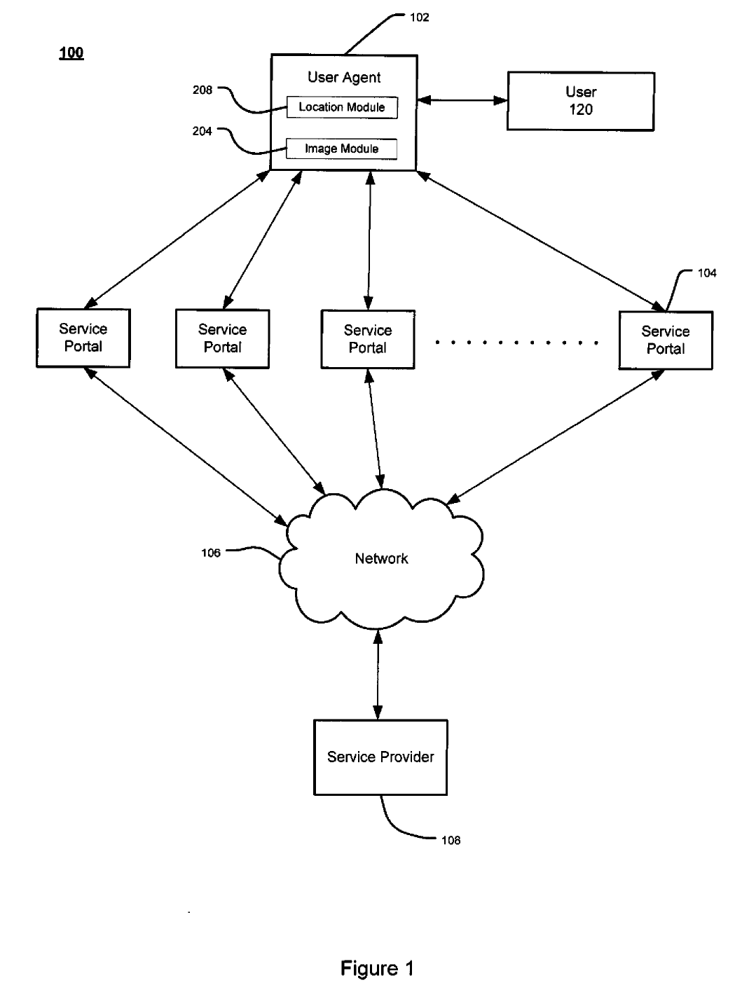

FIG. 1 illustrates a system for providing image geo-metadata mapping in accordance with exemplary embodiments. The system 100 may include a mobile user agent 102, a plurality of service portals 104, networks 106, and/or service providers 108. Although elements of the system 100 may be described as a single device, it will be appreciated that multiple instances of these devices may be included in the system 100. A user 120 associated with the mobile user agent 102 of the system 100. For example, the one or more service portals 104 may be located at disparate locations and/or coupled to the service providers 108 via the networks 106. The mobile user agent 102 may be coupled to the service provider 108 via the one or more service portals 104 located at disparate locations. Further, the mobile user agent 102 may include an image module 204 and/or a location module 208. The user 120 may utilize the image module 204 of the mobile user agent 102 to capture one or more images of a location. Also, the location module 208 may determine location information (e.g., associated with the location where the one or more images are taken). The one or more images and/or the location information associated with the location may be stored in the mobile user agent 102 in correspondence with one or more addresses in the contact address book stored in the mobile user agent 102.

The mobile user agent 102 may be, for example, but is not limited to, cellular telephones, SIP phones, software clients/phones, a desktop computer, a laptop/notebook, a server or server-like system, a module, a telephone, or a communication device, such as a personal digital assistant (PDA), a mobile phone, a smart phone, a remote controller, a personal computer (PC), a workstation, a mobile device, a phone, a handheld PC, a thin system, a fat system, a network appliance, and/or other mobile communication devices that may be capable of transmitting and/or receiving data. Also, the mobile user agent 102 may include one or more transceivers to transmit one or more signals to the service provider 108.

The mobile user agent 102 may include an image module 204. Although FIG. 1 illustrates a single image module 204 in the mobile user agent 102, it will be appreciated that multiple image modules 204 may be included in the mobile user agent 102. The image module 204 may be, but is not limited to, camera, camcorders, and/or other image capture devices. In an exemplary embodiment, the one or more image capture device 112 may capture one or more images having metadata and stored in exchangeable image file format (EXIF), tagged image file format (TIFF), and extensible metadata platform (XMP). In another exemplary embodiment, the one or more image module 204 may include one or more interfaces to allow a user 120 to input and/or modify metadata associated with the one or more images.

The mobile user agent 102 may include a location module 208. Although FIG. 1 illustrates a single location module 208 in the mobile user agent 102, it will be appreciated that multiple location modules 208 may be included in the mobile user agent 102. In an exemplary embodiment, the location module 208 may be, but is not limited to, a global positioning system (GPS), Geomagnetic sensors, GPS tracking devices, Geotagging devices, GSP logging devices, GSM localization devices, radio navigation devices, WiFi positioning system, and/or other location determination systems. In an exemplary embodiment, the location module 208 may be a global positioning system (GPS) that may utilize microwave signals to determine location information associated with the mobile user agent 102. The location modules 208 may be a geotagging device that may add location information associated with the mobile user agent 102 to one or more images as geospatial metadata. The location module 208 may be a geomagnetic sensor utilizing the Earth's magnetic field to determine location information associated with the mobile user agent 102. The location module 208 may include one or more graphical user interfaces to allow a user 120 to input and/or modify location information associated with the one or more mobile user agents 102.

The image module 204 and/or the location module 208 may be coupled to or integrated with the mobile user agent 102. For example, the image module 204 and/or the location module 208 may be external devices that wirelessly coupled and/or communicatively coupled to the mobile user agent 102. The image module 204 and/or location module 208 may be external devices communicatively coupled to the mobile user agent 102 via an interface port which may include, without limitation, USB ports, system bus ports, or Firewire ports and other interface ports. Also, the image module 204 and/or the location module may be wirelessly coupled to the mobile user agent 102. For example, For example, the image module 204 and/or the location module 208 may be wirelessly coupled to the mobile user agent 102 via a local area network (LAN). The local area network (LAN) may include, but is not limited to, infrared, Bluetooth™, radio frequency (RF), and/or other methods of wireless communication. According to another exemplary embodiment, the image module 204 and/or the location module 208 may be integrated with the mobile user agent 102. Further, computer code may be installed on the mobile user agent 102 to control and/or operate a function of the image module 204 and/or location module 208.

The one or more service portals 104 may be, for example, but is not limited to, a cellular telephone network signal tower, an Internet service provider router, a telephone adapter, a telephone router, an Ethernet router, a satellite router, a fiber optic router, a co-axial cable router, an Internet router, and/or other routing device that may provide and/or determine a transmission path for data to travel between networks. Furthermore, one or more service portals 104 may include a computer, software and/or hardware to facilitate a routing and/or forwarding function of a signal.

The network 106 may be a wireless network, a wired network or any combination of wireless, wired and/or other network. For example, the network 106 may include, without limitation, wireless LAN, Global System for Mobile Communication (GSM), Personal Communication Service (PCS), Personal Area Network (PAN), D-AMPS, Wi-Fi, Fixed Wireless Data, satellite network, IEEE 802.11a, 802.11b, 802.15.1, 802.11n and 802.11g and/or other wireless network. In addition, the network 106 may include, without limitation, telephone line, fiber optics, IEEE Ethernet 802.3, long-range wireless radio, wide area network (WAN) such as WiMax, infrared, Bluetooth™, and/or other similar applications, local area network (LAN), global network such as the Internet. Also, the network 106 may enable, a wireless communication network, a cellular network, an Intranet, or the like, or any combination thereof. The network 106 may further include one, or any number of the exemplary types of networks mentioned above operating as a stand-alone network or in cooperation with each other.

The service provider 108 may include one or more service providers for providing VoIP service and/or SIP service over Internet Protocol (IP) network and/or public switch telephone network (PSTN). For example, the service provider 108 may carry telephony signals (e.g., digital audio) encapsulated in a data packet stream over the Internet Protocol (IP) network. The service provider 108 may provide direct inward dialing (DID) VoIP services, SIP services, and/or access a service. For example, the service provider 108 may include one or more processors to provide services for the mobile user agent 102. Further, the service provider 108 may include one or more databases to store the one or more images, location information and/or one or more persons associated with the mobile user agent 102. In an exemplary embodiment, the service provider 108 may provide one or more websites and/or webpages to input and/or modify location information and/or one or more persons associated with the mobile user agent 102.

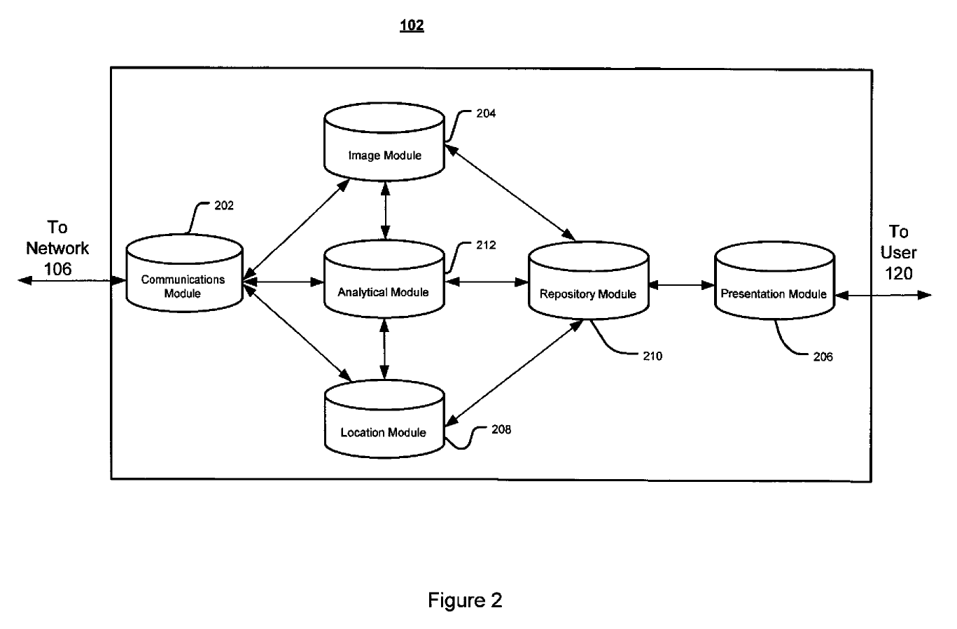

FIG. 2 illustrates a detailed block diagram of a mobile user agent, in accordance with exemplary embodiments. For example, the mobile user agent 102 may include a communication module 202, an image module 204, a presentation module 206, a location module 208, a repository module 210, and/or an analytical module 212. It is noted that the modules 202, 204, 206, 208, 210, and 212 are exemplary and the functions performed by one or more of the modules may be combined with that performed by other modules. The functions described herein as being performed by the modules 202, 204, 206, 208, 210, and 212 also may be separated and may be performed by other modules at devices local or remote to the mobile user agent 102. The image module 204 may capture an image at a location, wherein the image may have metadata. Also, the location module 208 may determine location information associated with the location, before, simultaneously to or at about the same time, and/or after the image taken by the image module 204. The image module 204 and/or the location module 208 may provide the image and/or the location information to the analytical module 212. The analytical module 212 may establish a relationship (e.g., a correlation) between the image and the location information, for example, add the location information to the metadata of the image. In another exemplary embodiment, the analytical module 212 may obtain from and/or provide to the repository module 210, an address in a contact address book. The analytical module 212 may add the address in the contact address book to the metadata of the image. Therefore, the user 120 may identify the address in the contact address book with the image including the location information. The analytical module 212 may provide the image including the location information and/or the address in the contact address book to the communication module 202 and transfer to the service provider 108 via the network 106. Also, the analytical module 212 may provide the image including the location information and/or the address to the repository module 210, and stored. The presentation module 206 may present the image including the location information and/or the address in the contact address book to the user 120. The user 120 may revise the image including the location information and/or the address in the contact address book.

Although as described above, a single image may be captured by the image module 204 at a location, it will be appreciated that a plurality of images may be captured by the image module 208 at the location. The analytical module 212 may establish a relationship between the plurality of images and the location information, for example, add the location information to the metadata of the plurality of images. Also, the analytical module 212 may add the address in the contact address book to the plurality of images having the location information. In another exemplary embodiment, the analytical module 212 may obtain from and/or provide to the repository module 210 a plurality of addresses in a contact address book. The analytical module 212 may add the plurality of addresses in the contact address book to the metadata of the plurality of images.

The mobile user agent 102 may communicate with the service provider 108 via the communication module 202. For example, the communication module 202 may receive one or more signals from, the image module 204, the location module 208, the repository module 210, and/or the analytical module 212. In an exemplary embodiment, the mobile user agent 102 may transmit one or more images, location information, one or more addresses from a contact address book, and/or other information associated with the mobile user agent 102 to the service provider 108 via the communication module 202. For example, the mobile user agent 102 may transmit one or more registration signals to establish a connection with the service provider 108 via the network 106. The mobile user agent 102 may transmit one or more notify signals to the service provider 108 to notify location information and/or one or more images taken by the image module 204 associated with the one or more addresses of the contact address book. In addition, the mobile user agent 102 may transmit one or more update signals to the service provider 108 to update location information and/or the one or more images taken by the image module 204 associated with the one or more addresses of the contact address book. In an exemplary embodiment, the mobile user agent 102 may transmit one or more registration signals, one or more notify signals, and/or one or more update signals continuously, periodically, and/or intermittently.

In an exemplary embodiment, the communication module 202 may transmit one or more registration signals from the mobile user agent 102 to the service provider 108. The one or more registration signals may include, for example, but is not limited to, user identification information (e.g., name, address, telephone number), location information (e.g., physical street address and/or global positioning system (GPS) coordinates), images, date, time, types of mobile user agent, types of services provided, transmission frequency, transmission rate, username, password, types of network etc. For example, the mobile user agent 102 may transmit one or more registration signals when turned on. Also, in the event that the mobile user agent 102 loses services with the service provider 108, the mobile user agent 102 may transmit one or more registration signals when the mobile user agent 102 may be attempting to reestablish a service with the service provider 108. The mobile user agent 102 may transmit the one or more registration signals continuously, periodically, or intermittently. Also, the mobile user agent 102 may transmit one or more notify signals and/or Update signals to the service provider 108. For example, the one or more notify signals and/or Update signals may include name, address, telephone number, location information, one or more images, date, time, types of mobile user agent, types of services provided, and/or other information transmitted by the mobile user agent 102.

The image module 204 may capture one or more images associated with a location. For example, user 120 may utilize the image module 204 to capture an image associated with a location. The image associated with a location may include metadata associated with one or more characteristics associated with the image. The metadata of the image may include image date, image module settings (e.g., lens, focal length, aperture, shutter timing, white balance), image name, size of the images, type of images, image directories, and/or other characteristics associated with the images. Also, the image module 204 may capture a plurality of images associated with a location having metadata. The image module 204 may provide the image to the repository module 210 for storing and/or the analytical module 212 for further processing.

The location module 208 may include one or more processors to determine location information such as the physical street address, global positioning system (GPS) coordinates, geocoded data, and/or other formats of location information. Also, the location module 208 may determine location information based at least in part on human input location information. The location module 208 may determine location information before, simultaneously to or about the same time, and/or after the image taken by the image module 204. In an exemplary embodiment, the location module 208 may determine location information simultaneously to or about the same time the image module 204 takes the image. In another exemplary embodiment, the location module 208 may determine location information after (e.g., immediately after and/or soon after) the image module 204 taken the image. In other exemplary embodiments, the location module 208 may determine location information before the image module 204 taking the image. The location module 208 may include one or more databases to store location information determined by the location module 208. The location module 208 may also provide location information determined by the location module 208 to the repository module 206 for storing and/or the analytical module 212 for processing.

The location module 208 may determine location information of one or more nearby service portals 104. For example, the image module 204 may take an image at a location nearby one or more service portals 104, the location module 208 may determine the location information of the one or more nearby service portals 104. In a particular embodiment, the location module 208 may not determine an exact location when the image is taken, therefore, the location module 208 may determine location information associated with one or more nearby service portals 104 to identify location information of nearby the location when the image is taken. The location module 208 may determine the location information of a closest nearby service portal 104 when the image is taken. The location module 208 may determine a predetermined number of nearby service portals 104 when the image is taken.

The location module 208 may determine and/or store location information associated with the mobile user agent 102. The location module 208 may map a geographical layout based at least in part on the location information associated with the mobile user agent 102. Also, the location module 208 may determine and/or store location information when an image is taken by the image module 204. For example, mapping information of the location module 208 may be imported and/or updated by commercially available mapping sources to visually locate the location information determined by the location module 208 on a geographical map. These mapping sources may include Google Maps™, GoogleEarth™, MapQuest™, Yahoo Maps™, and/or other electronic mapping sources. The geographical location determined by the location module 208 may be mapped and/or stored in the location module 208 and/or the repository module 210. Also, the location module 208 may determine location information and/or map the geographical location of the one or more service portals 104. The location module 208 may determine location information and/or map geographical location of the one or more nearby service portals 104 when the image is taken by the image module 204. In addition to storing the information identified above, the location module 208 may also determine and/or record past location information determined by the location module 208 to provide an indication of the geographical regions, the mobile user agent 102 is most likely to be associated with. The location module 208 may provide direction information (e.g., driving direction, flying direction).

The repository module 210 may store and/or manage data from the image module 204, the location module 208, and/or the analytical module 212. The repository module 210 may provide a graphical user interface, e.g., an uniform interface, for other modules within the mobile user agent 102 and may write, read, and search data in one or more repositories or databases. The repository module 210 may include one or more databases to store a contact address book associated with the user 120. The contact address book associated with the user 120 may be a database and/or a directory containing one or more addresses. The contact address book associated with the user 120 may include addresses (e.g., name, phone numbers, physical addresses, email addresses) of one or more persons, organizations, and/or governmental institution. The repository module 210 may also perform other functions, such as, but is not limited to, concurrent access, backup and archive functions. Also, due to limited amount of storing space the repository module 210 may compress, store, transfer and/or discard the data stored within after a period of time. The repository module 210 may provide data to the analytical module 212.

The analytical module 212 may process data from the image module 204, the location module 208, and/or the repository module 210. The analytical module 212 may further include a plurality of sub-analytical modules to perform various types of data processing. In an exemplary embodiment, the analytical module 212 may receive and/or obtain one or more images from the image module 204. The analytical module 212 may also receive and/or obtain location information from the location module 208. The analytical module 212 may receive and/or obtain one or more addresses from the contact address book from the repository module 210. The analytical module 212 may process data by correlating the location information from the location module 208 to the images from the image module 204. The analytical module 212 may add location information to metadata associated with the images from the image module 204. In another exemplary embodiment, the analytical module 212 may process the one or more images from the image module 204, location information from the location module 208, and/or one or more addresses of a contact address book from the repository module 210. The analytical module 212 may correlate the location information from the location module 208 and/or the one or more addresses of a contact address book from the repository module 210 to the one or more images from the image module 204. For example, the analytical module 212 may add the location information from the location module 208 to the metadata of an image from the image module 204. Also, the analytical module 212 may add address of the contact address book from the repository module 210 to the metadata of the image from the image module 204. Therefore, the user 120 may identify location information of the address in the contact address book via the image. The analytic module 212 may analyze data from image module 204, the location module 208, and/or the repository module 210 and store the analysis results in the repository module 210. For example, the analytical module 212 may provide the image including location information associated with an address in the contact address book to the repository module 210 and stored. In another exemplary embodiment, the analytical module 212 may provide an image including location information associated with an address in the contact address book to the service provider 108, and stored in the service provider 108.

The presentation module 206 may include an Application Programming Interface (API) to interact with the user 120. The presentation module 206 may present one or more addresses in the contact address book including location information and/or one or more images to the user 120. The user 120 may view the address in the contact address book including the location information and/or the image. Also, the user 120 may verify whether the location information and/or the image are associated with the corrected address in the contact address book. In the event that the location information and/or the image are not associated with the corrected address in the contact address book, the user 120 may modify the location information and/or the image associated with the corrected address in the contact address book. In an exemplary embodiment, the location information associated with the address of the contact address book may not be accurate (e.g., location information of one or more nearby service portals 104) and therefore the user 120 may modify the location information (e.g., inputting physical street address and/or global positioning system (GPS) coordinates). In another exemplary embodiment, the image associated with the address in the contact address book may become inaccurate and therefore the user 120 may replace the image and/or the address in the contact address book (e.g., replace the inaccurate image). Also, the location information associated with the address of the contact address book may be out of date and therefore the user 120 may update the location information (e.g., inputting physical street address and/or global positioning system (GPS) coordinates).

In another exemplary embodiment, in response to receiving a request from the user 120 to display the one or more images and/or location information associated with the one or more addresses in the contact address book via the presentation module 206, the presentation module 206 may send requests (or control signals, etc.) to the repository module 210 and/or the analytical module 212. In response to a request, the repository module 210 may provide one or more images and/or location information associated with the one or more addresses in the contact address book to the presentation module 206. Also, the analytical module 212 may (a) receive data from image module 204, the location module 208 and/or the repository module 210, (b) analyze the data, and (c) provide data and/or analysis result to the presentation module 206. The presentation module 206 may provide the data and/or analysis results to the user 120 for viewing. As a result, the mobile user agent 120 may allow the user 120 to identify the location information associated with the address in the contact address book via one or more images. Also, the mobile user agent 120 may allow the user 120 to automatically obtain location information associated with the address in the contact address book via the location module 208.

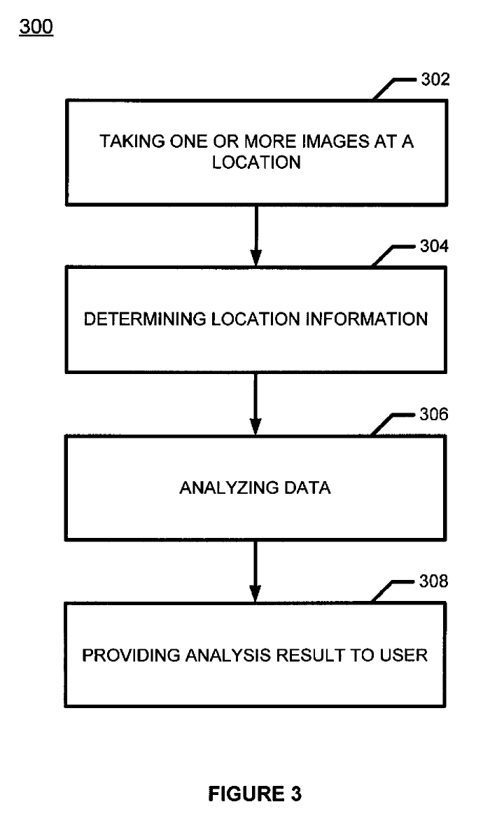

FIG. 3 illustrates a flowchart for providing image geo-metadata mapping, in accordance with exemplary embodiments. This exemplary method is provided by way of example, as there are a variety of ways to carry out methods disclosed herein. The method 300 shown in FIG. 3 can be executed or otherwise performed by one or a combination of various systems. The method 300 is described below as carried out by system 100 shown in FIGS. 1 and 2 by way of example, and various elements of system 100 are referenced in explaining the example method of FIG. 3. Each block shown in FIG. 3 represents one or more processes, methods, or subroutines carried in the exemplary method 300. The method 300 may begin at block 302.

At block 302, one or more images may be taken at a location. In an exemplary embodiment, a user 120 may travel to a desired location and/or a location of interest. The user 120 may utilize an image module 204 of mobile user agent 102 (e.g., a camera on the cell phone) to take one or more images at the location. The image may include metadata information. The metadata information of the image may include image date, image module settings (e.g., lens, focal length, aperture, shutter timing, white balance), image name, size of the images, type of images, image directories, and/or other characteristics associated with the images. The image module 204 may provide the one or more images to a repository module 210 for storing and/or an analytical module 212 for further processing. After the one or more images may be taken at the location, the method 300 may proceed to block 304.

At block 304, location information may be determined. For example, a location module 208 may determine location information associated with a location, before, simultaneously to or at about the same time, and/or after the one or more images are taken by the image module 204. The location module 208 may determine geographical information such as the physical street address, global positioning system (GPS) coordinates and/or other formats of location information. Also, the location module 208 may determine mapping information of the location information. For example, the location module 208 may include commercially available mapping sources to visually locate the location determined by the location module 208 on a geographical map. The user 120 may enter location information via human input, before, simultaneously to or at about the same time, and/or after the images are taken by the image module 204. The location module 208 may provide location information to the repository module 206 for storing and/or the analytical module 212 for processing. After determining the location information, the method 300 may proceed to block 306.

At block 306, data may be analyzed. The analytical module 212 may process data from the image module 204, the location module 208, and/or the repository module 210. In an exemplary embodiment, the analytical module 212 may receive and/or obtain the one or more images from the image module 204, the location information from the location module 208, and/or the one or more addresses from the contact address book in the repository module 210. In an exemplary embodiment, the analytical module 212 may include location information to metadata associated with the image from the image module 204. In another exemplary embodiment, the analytical module 212 may correlate the location information from the location module 208 and/or the address of a contact address book from the repository module 210 to the image from the image module 204. The analytical module 212 may transfer the processed data to the repository module 206 and/or to the service provider 108 (e.g., via the communication module 202), and stored. After analyzing the data, the method 300 may proceed to block 308.

At block 308, the analysis results are provided to the user. For example, a presentation module 206 may display the analysis results to the user 120. The presentation module 206 may display the one or more addresses in the contact address book including location information and/or one or more images to the user 120. The user 120 may view the address in the contact address book including location information and/or the image. Also, the user 120 may verify whether the location information and/or the image are associated with the corrected address in the contact address book.

It should be appreciated that exemplary embodiments may be implemented as a method, a data processing system, or a computer program product. Accordingly, exemplary embodiments may take the form of an entirely hardware embodiment, an entirely software embodiment, or an embodiment combining software and hardware aspects. Furthermore, implementations of the exemplary embodiments may take the form of a computer program product on a computer-readable storage medium having computer-readable program instructions (e.g., computer software) embodied in the storage medium. More specifically, implementations of the exemplary embodiments may take the form of web-implemented computer software. Any suitable computer-readable storage media may be utilized including hard disks, CD-ROMs, optical storage devices, magnetic storage devices, or other similar computer readable/executable storage media.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A method, comprising:
capturing one or more images associated with a location, wherein metadata is associated with each of the one or more images;
determining location information associated with the location;
obtaining one or more addresses in a contact address book;
processing the metadata associated with the one or more images, the location information, and the one or more addresses in the contact address book by correlating at least two of the metadata associated with the one or more images, the location information, and the one or more addresses in the contact address book; and
displaying result of the correlation of at least two of the metadata associated with the one or more images, the location information, and the one or more addresses in the contact address book to a user.

2. The method of claim 1, wherein the metadata include at least one of image date, image module settings, image name, size of the one or more images, type of images, and image directories.

3. The method of claim 1, wherein determining the location information associated with the location is done at about the same time as the capturing of the one or more images.

4. The method of claim 1, wherein determining the location information associated with the location is done after capturing the one or more images.

5. The method of claim 1, wherein determining the location information associated with the location is done before capturing the one or more images.

6. The method of claim 1, the location information includes at least one of a physical street address and global positioning system (GPS) coordinates.

7. The method of claim 1, wherein the one or more addresses includes at least one of a name, a phone number, a physical address, and a email address.

8. The method of claim 1, wherein obtaining the one or more addresses in the contact address book comprises obtaining the one or more addresses in the contact address book from a repository module.

9. The method of claim 1, wherein processing the metadata associated with the one or more images, the location information, and the one or more addresses in the contact address book by correlating the location information to the metadata associated with the one or more images.

10. The method of claim 9, wherein correlating the location information to the metadata associated with the one or more images comprises adding the location information to the metadata associated with the one or more images.

11. The method of claim 1, wherein processing the metadata associated with the one or more images, the location information, and the one or more addresses in the contact address book by correlating the one or more addresses in the contact address book to the metadata associated with the one or more images.

12. The method of claim 11, wherein correlating the one or more address in the contact address book to the metadata associated with the one or more images comprises adding the one or more address in the contact address book to the metadata associated with the one or more images.

13. The method of claim 1, wherein processing the metadata associated with the one or more images, the location information, and the one or more addresses in the contact address book by correlating the location information and the one or more addresses in the contact address book to the metadata associated with the one or more images.

14. The method of claim 13, wherein correlating the location information and the one or more addresses in the contact address book to the metadata associated with the one or more images comprises adding the location information and the one or more addresses in the contact address book to the metadata associated with the one or more images.

15. The method of claim 1, further comprises the user modifying the correlation of at least two of the metadata associated with the one or more images, the location information, and the one or more addresses in the contact address book.

16. A computer readable media comprising code to perform the steps of the methods of claim 1.

17. A system, comprising:
an image module configured to capture one or more images a location, wherein metadata is associated with each of the one or more images;
a location module configured to determine location information associated with the location;
a repository module configured to store one or more addresses in a contact address book;
an analytical module configured to process the metadata associated with the one or more images, the location information, and the one or more addresses in the contact address book by correlating at least two of the metadata associated with the one or more images, the location information, and the one or more addresses in the contact address book; and
a presentation module configured to display result of the correlation of the at least two of the metadata associated with the one or more images, the location information, and the one or more addresses in the contact address book to a user.

18. The system of claim 17, wherein the location module is configured to determine the location information associated with the location at about the same time as the image module captures the one or more images.

19. The system of claim 17, wherein the location module is configured to determine the location information associated with the location after the image module captures the one or more images.

20. The system of claim 17, wherein the location module is configured to determine the location information associated with the location before the image module captures the one or more images.

21. The system of claim 17, wherein the analytical module configured to process the metadata associated with the one or more images, the location information, and the one or more addresses in the contact address book by correlating the location information to the metadata associated with the one or more images.

22. The system of claim 21, wherein correlating the location information to the metadata associated with the one or more images comprises adding the location information to the metadata associated with the one or more images.

23. The system of claim 17, wherein the analytical module configured to process the metadata associated with the one or more images, the location information, and the one or more addresses in the contact address book by correlating the one or more addresses in the contact address book to the metadata associated with the one or more images.

24. The system of claim 23, wherein correlating the one or more address in the contact address book to the metadata associated with the one or more images comprises adding the one or more address in the contact address book to the metadata associated with the one or more images.

25. The system of claim 17, wherein the analytical module configured to process the metadata associated with the one or more images, the location information, and the one or more addresses in the contact address book by correlating the location information and the one or more addresses in the contact address book to the metadata associated with the one or more images.

26. The system of claim 25, wherein correlating the location information and the one or more addresses in the contact address book to the metadata associated with the one or more images comprises adding the location information and the one or more addresses in the contact address book to the metadata associated with the one or more images.
